(19) United States
(12) Patent Application Publication
(10) Pub. No.: US 2015/0259025 A1
(43) Pub. Date: Sep. 17, 2015

(54) SHIFTER LEVER FOR A BICYCLE

(71) Applicant: TIEN HSIN INDUSTRIES CO., LTD., Taichung City (TW)

(72) Inventors: ALFREDO SALA, Taichung City (TW); DOUGLAS CHIANG, Taichung City (TW)

(73) Assignee: TIEN HSIN INDUSTRIES CO., LTD., Taichung City (TW)

(21) Appl. No.: 14/211,669

(22) Filed: Mar. 14, 2014

(51) Int. Cl. B62K 23/06; F16H 59/04

(52) U.S. Cl. CPC B62K 23/06; F16H 59/044

(57) ABSTRACT

A shifter lever includes a main body made of metals and the main body is disposed with a wireless control unit therein and the wireless control unit is electrically connected with the main body. In addition, the main body is used as an antenna for wirelessly controlling a bicycle derailleur mechanism. Because the metal frame of the shifter lever is used as an antenna, not only the quality of received signals is improved, but the space and the weight of the connecting base are saved and reduced.

### BACKGROUND OF THE INVENTION

1. Field of Invention

The present invention relates to a shifter lever, and more particularly, to a shifter lever disposed with a wireless control unit for controlling an electronic speed change system, so as to operate a bicycle speed change mechanism wirelessly.

2. Related Art

Bicycles are a small vehicle driven by man power. Whether the bicycle is used for recreation, transportation or competition, the components of bicycles are constantly improved, and the speed change device like a derailleur is one of the bicycle components, which has been improved continuously by the manufactures.

In past, an operation force by a finger, applied to a shifter lever, is transmitted to a derailleur by a cable fixed on one end of the shifter lever. However, in recent years, an electronic switch installed on the handlebar of a bicycle is used to replace the shifter lever to operate the derailleur or an electronic derailleur, in which a plurality of electronic switches is disposed in the handlebar, so as to achieve quicker gear-shifting and enhance responses.

In some bicycle models, the shifter lever and the brake lever may be combined as a whole unit, or in other models, they may be separate units. In addition, In the case of road bicycles having a drop handlebar, the shifter lever and the brake lever are mostly combined as a whole unit; however, under some conditions, the functions of the brake lever and the shifter lever may be combined as a single lever.

No matter whether the shifter lever and the brake lever are combined as a whole unit or the shifter lever and the brake lever are constituted by a plurality of control lever sets, the antenna and the electrical signal control circuit board of the existing wireless electronic shifter are disposed in a connecting base between the handlebar and the control lever, so that the connecting base requires a larger space for disposing the whole control elements, which has led to a problem of increasing weight of the connecting base.

### SUMMARY OF THE INVENTION

Therefore, in order to overcome the mentioned drawbacks, one objective of the present invention is to provide a shifter lever, in which the wireless control unit is disposed inside the shifter lever, so as to reduce the volume and weight of the connecting base.

Another objective of the present invention is to provide a shifter lever, in which the metal frame of the shifter lever is used as an antenna, so as to reduce space for receiving the antenna and material costs, as well as the volume and weight of the connecting base.

In order to achieve the mentioned objectives, the present invention discloses a shifter lever for controlling the speed change system of bicycles wirelessly. The shifter lever comprises a main body made of metals and having a receiving space. A wireless control unit disposed in the receiving space, and electrically connected with the main body. Through the main body used as an antenna for wireless transmission, the shifter lever can wirelessly control the speed change mechanism of the bicycle.

The advantage of the present invention is to provide a shifter lever with the metal frame and an elongated surface area to be used as an antenna. The power unit, the signal transceiver, and the signal processor are integrated into a single wireless control unit and disposed in the shifter lever, such that the weight and volume of the whole shifter lever can be reduced and the signal receiving quality can be increased according to the elongated metal frame.

### BRIEF DESCRIPTION OF THE DRAWINGS

The present invention will become more fully understood from the detailed description given herein below for illustration only, which thus is not limitative of the present invention, and wherein:

FIG. 1 is a perspective view according to one embodiment of the present invention.

FIG. 2 is an exploded view according to the present invention.

FIG. 3 is a detailed exploded view according to the present invention.

FIG. 4 is a perspective view in use thereof according to one embodiment of the present invention.

FIG. 5 is a perspective view in use thereof according to another embodiment of the present invention.

### DETAILED DESCRIPTION OF THE INVENTION

The embodiments of the present invention will be described with reference to accompanying drawings. It should be noted that the embodiments of the present invention are used for the purpose of illustration only, but should not be limited thereto.

The present invention provides a shifter lever, in which at least one wireless control unit is installed to operate the speed change mechanism such like a derailleur system, so that the derailleur system can be wirelessly controlled by the wireless control unit; therefore, a quick gear shifting can be achieved.

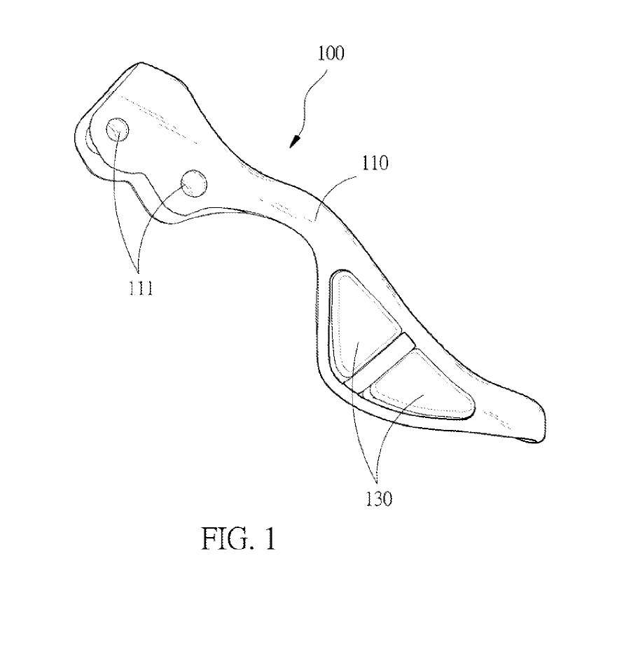

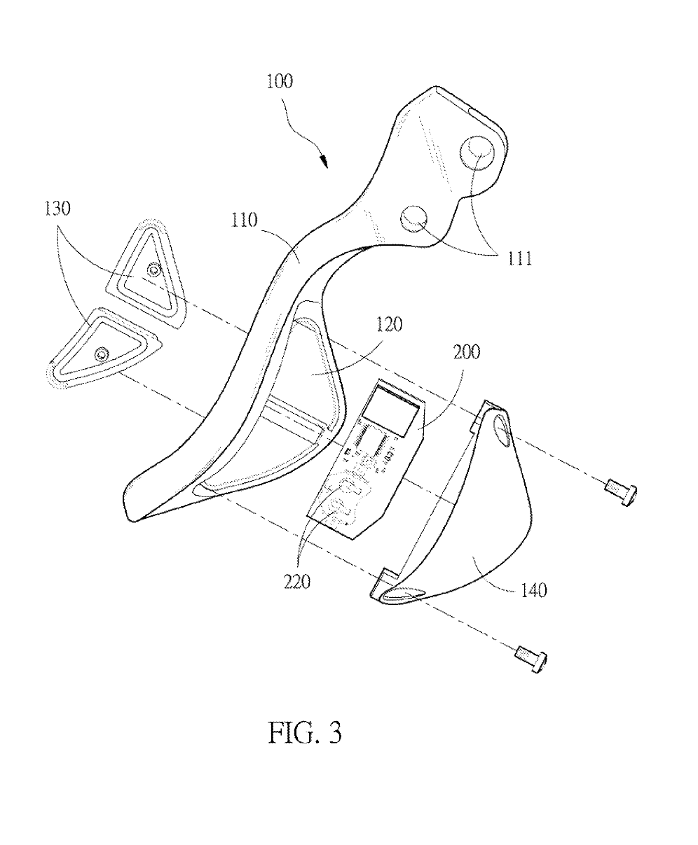

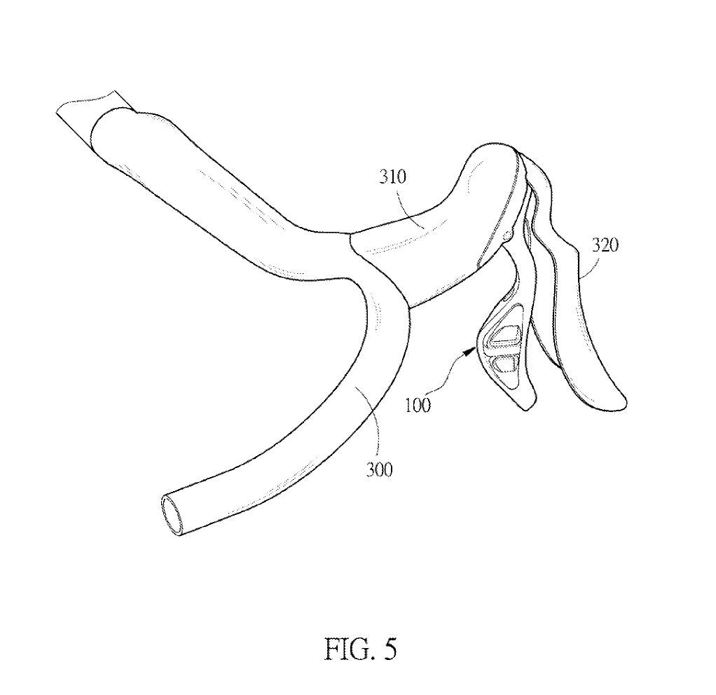

Refer to FIG. 1 to FIG. 3, the shifter lever 100 comprises a main body 110. The main body 110 is made of metals and has a connecting portion 111 at one end thereof, and the connecting portion 111 is used to connect the shifter lever 100 with a handlebar of a bicycle. Usually, it is fixed to a connecting base 310 and then fixed to a handlebar 300 as shown in FIG. 5.

The main body 110 has a receiving space 120, and the receiving space 120 is used to receive a wireless control unit 200. The wireless control unit 200 includes electronic components for controlling the derailleur system of the bicycle wirelessly, such like at least a signal transceiver, a signal processor and an encoder are integrated into the wireless control unit 200. In addition, the wireless control unit 200 is electrically connected with the main body 110 and uses the metal frame of the main body 110 and its elongated surface area as an antenna to wirelessly control the derailleur system of the bicycle.

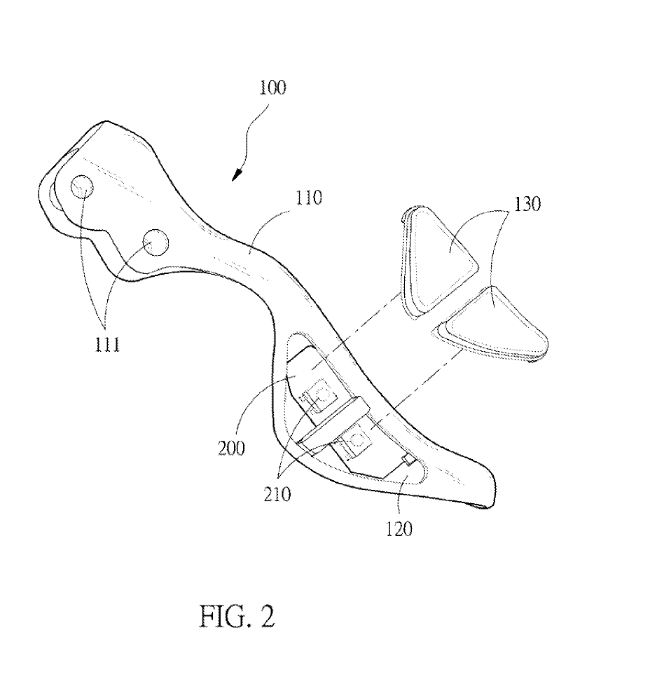

Furthermore, in the embodiment, as shown in FIG. 2, the wireless control unit 200 is provided with two signal input member 210, so that the wireless control unit 200 can select what gear to be shifted in the derailleur system. In addition, the main body 110 is provided with two control members 130 thereon, and the two control members 130 are disposed adjacent to the signal input member 210 of the wireless control unit 200, so as to control the two signal input members 210. In practice, the two control members 130 of the main body 110 can directly control the two signal input members 210 to reduce the problems of signal reduction and noise during the current transmitting.

In the present embodiment, the two control members 130 can be covered by a coat made of a flexible silicon resin or a rigid material with water proof function to wrap the two signal input members 210 and avoid corrosion from moisture or water. Also, the main body 110 can be wrapped with an outer coat made of non-metal so as to avoid oxidation of metal and electric shock caused by electrostatic charges due to dry weather.

Moreover, the wireless control unit 200 is installed with at least one power unit 220 and there are two power unit 220 installed in the present embodiment. The power unit 220 can independently provide required electrical power to the wireless control unit 200, so that it can omit the wiring of the main body for connecting to an external power and make the main body to be installed easily by a user.

The main body 110 further has a cover 140 to cover the receiving space 120. Thus, with the design of the cover 140, it can benefit the wireless control unit 200 to avoid a malfunction caused by moisture and to simplify the replacement or maintenance of the power unit 220 and the wireless control unit 200.

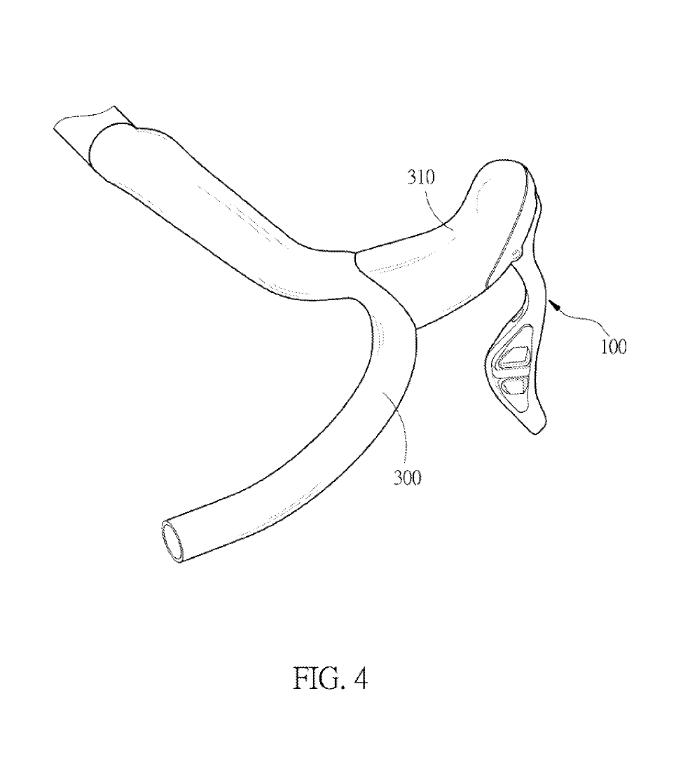

Please refer to FIG. 4 and FIG. 5, they are perspective views of the shifter lever 100 in use. The shifter lever 100 may also have a brake function, so that the derailleur system and the brake system can be integrated into a whole system, and the whole system can be fixed to a connecting base 310 of a bicycle handlebar 300 through the connecting portion 111 as shown in FIG. 4.

In another embodiment as shown in FIG. 5, the shifter lever 100 is fixed to the connecting base 310 of the bicycle handlebar 300 through the connecting portion 111, and the connecting base 310 has a brake lever 320, so that the derailleur system and the brake system are separated as individual units.

Although the present invention is disclosed through the above embodiments, the embodiments are not intended to limit the present invention. Equivalent replacements like variations and modifications made by any person skilled in the similar art without departing from the spirit and scope of the present invention shall still fall within the protection scope of the present invention.

What is claimed is:

1. A shifter lever connected to a bicycle for wirelessly controlling a speed change mechanism of the bicycle, the shifter lever comprising:
a main body, made of metals and having a receiving space; and
a wireless control unit, disposed in the receiving space and electrically connected with the main body, and the main body being used as an antenna for the wireless control unit to wirelessly control the speed change mechanism.

2. The shifter lever according to claim 1, wherein the wireless control unit comprises at least one signal input member for controlling the wireless control unit.

3. The shifter lever according to claim 2, wherein the main body comprises at least one control member, and the control member is disposed adjacent to the signal input member of the wireless control unit for controlling the signal input member.

4. The shifter lever according to claim 3, wherein the control member of the main body is used to directly control the signal input member.

5. The shifter lever according to claim 1, wherein the wireless control unit is disposed with a power unit.

6. The shifter lever according to claim 1, wherein the main body is disposed with a cover, and the cover is used to cover the receiving space.

7. The shifter lever according to claim 1, wherein the main body is wrapped with an outer coat made of non-metal material.

8. The shifter lever according to claim 1, wherein the main body further comprises a connecting portion at one end connected to a connecting base, and the connecting base is connected to the bicycle.
